(19) United States
(12) Patent Application Publication
(10) Pub. No.: US 2006/0285168 A1
(43) Pub. Date: Dec. 21, 2006

(54) Copy system, image forming apparatus, server, image formation method, and computer program product

(75) Inventors: Yasuo Horino, Tokyo (JP); Kohji Taguchi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd

(21) Appl. No.: 11/258,067

(22) Filed: Oct. 26, 2005

(30) Foreign Application Priority Data
Jun. 21, 2005 (JP) 2005-181257

(51) Int. Cl. H04N 1/40

(52) U.S. Cl. 358/3.28; 358/1.15

(57) ABSTRACT

A copy system comprises: a server identifying a second electronic document corresponding to a first electronic document; and an image forming apparatus that forms a second code image on a medium instead of a first code image in accordance with an instruction to copy the medium, the second code image corresponding to the second electronic document identified by the server, the first code image corresponding to the first electronic document and being formed on the medium.

### BACKGROUND OF THE INVENTION

1. Field of the Invention

The present invention relates to image forming apparatus such as a copier, a server for generating an image output on the image forming apparatus, and a copy system including the image forming apparatus and the server.

2. Description of the Related Art

In recent years, a technology has attracted attention whereby a user draws a character or a picture on a special sheet of paper on which small dots are printed and transfers the data of a character he/she wrote on the sheet to a PC (Personal Computer) or a cell phone for storage of e-mail transmission of the content. In this technology, small dots are printed for example in intervals of 0.3 mm on the special sheet so as to draw a different pattern for each lattice having a predetermined size. The pattern is read by using a dedicated pen incorporating a digital camera to identify the position of a character written on the special sheet, thereby utilizing such a character as electronic information.

A related art technology described in an official gazette links an electronic document with a sheet of paper on which the electronic document is printed in order to merge a character written on the sheet and the electronic document. To be more specific, identification information on a page of an electronic document and information on the position on the sheet are embedded into a code image, typically a machine-readable two-dimensional code, and printed on the electronic document in an overlaid fashion on a printer. Next, a pen type scanner is used to continuously acquire writing operations on the printed document and partial images in the written portion from the printed document. The acquired image is then analyzed to detect the identification information on a page of the electronic document and the information of multiple positions of the partial images on the printed document. Then, the detected identification information is used to identify the page of the original electronic document as well as reproduce the content of writing on the printed document by using information on the multiple positions. This makes it possible to add the content of writing to the page of the original electronic document.

Another related art technology embeds information on the link-destination into a sheet of paper. In the related art described above, a printed matter with an invisible water marking embedded is photographed with a mobile terminal and is transmitted to a server, which returns a corresponding URL to the mobile terminal.

Further, a technology is known that manages copy relation between media. In the above mentioned related art, an ID is embedded into a medium and the ID is replaced with a new ID in the copy process so as to associate the ID of the copy-from medium with the ID of the copy-to medium.

### SUMMARY OF THE INVENTION

The related arts described above does not assume the information embedded into a sheet of paper will be updated. The technology according to JP-B-3584540 assumes updating of information embedded into a sheet of paper although an update of embedded information does not correspond to an update of data of the electronic document associated with the sheet.

Thus, for example, even in case the electronic data as a source of an image printed on a sheet (hereinafter referred to as “manuscript data”) or electronic data accessible based on the information embedded in a sheet (hereinafter referred to as “reference data”) is updated, that is, upgraded, it is not possible to update the information embedded into a sheet in accordance with the update. This makes it necessary to perform a cumbersome and time-consuming task of searching for the latest electronic data from a PC and performing printing based on the latest electronic data.

The present invention has been made in view of the above circumstances and provides a copy system. According to an aspect of the invention, there is provide with a copy system including: a server identifying a second electronic document corresponding to a first electronic document; image forming apparatus for forming; and a second code image corresponding to the second electronic document identified by the server in accordance with an instruction to copy a medium on which a first code image corresponding to the first electronic document is formed, instead of the first code image.

According another aspect of the invention, there is provided with an image forming apparatus including: an acceptance part for accepting an instruction to copy a medium on which a first code image corresponding to first data is formed; an image acquiring part for acquiring an image including a second code image corresponding to the first data instead of the first code image, in accordance with the copy instruction; and a printing part for printing an image acquired by the image acquiring part on a medium.

A server is in the copy system. According to another aspect of the invention, there is provided with a server including: a first identification information acquiring part for acquiring first identification information obtained by scanning a medium on which an image including the first identification information is formed; a first data identification part for identifying first data corresponding to the first identification information acquired by the first identification information acquiring part; a second data identification part for identifying second data corresponding to the first data identified by the first data identification part; a second identification information acquiring part for acquiring second identification information corresponding to the second data identified by the second data identification part; and an image generation part for generating an image including the second identification information but not the first identification information.

According to another aspect of the invention, a method is to form an image by using the image forming apparatus. In such a case, according to another aspect of the invention, there is provided with an image formation method including: accepting an instruction to copy a medium on which a first code image corresponding to a first electronic document; acquiring an image including a second code image corresponding to a second electronic document related to the first electronic document; and printing the acquired image on a medium.

According to another aspect of the invention, there is provided with a computer program product for enabling a computer to perform to generate an image, comprising: a function to acquire first identification information obtained by scanning a medium on which an image including the first identification information is formed; a function to identify a first electronic document corresponding to the first identification information; a function to identify a second electronic document corresponding to the first electronic document; a function to acquire second identification information corresponding to the second electronic document; and a function to generate an image including the second identification information but not the first identification information.

### BRIEF DESCRIPTION OF THE DRAWINGS

FIG. 1 shows an exemplary configuration of a system according to an embodiment of the invention;

FIG. 2 shows an exemplary configuration of an identification information server according to an embodiment of the invention;

FIG. 3 shows an example of storage content in a corresponding information DB according t an embodiment of the invention;

FIG. 4 illustrates a two-dimensional code image printed on a medium according to an embodiment of the invention;

FIG. 5 shows the management of versions of an electronic document according to an embodiment of the invention;

FIG. 6 is a block diagram showing the functional configuration of image forming apparatus related to the operation from a scan instruction to output of an image according to an embodiment of the invention;

FIG. 7 is a flowchart showing the operation related to acquisition of identification information in the image forming apparatus according to an embodiment of the invention;

FIG. 8 is a flowchart showing the operation related to acquisition of version information in the identification information server according to an embodiment of the invention;

FIG. 9 is a flowchart showing the operation related to specification of a version of an electronic document and a method for adding code information in the image forming apparatus according to an embodiment of the invention;

FIG. 10 is a flowchart showing the operation related to image generation in accordance with a copy instruction in the identification information server according to an embodiment of the invention;

FIG. 11 shows an example of the updated storage content of the corresponding information DB according to an embodiment of the invention; and

FIG. 12 shows an exemplary configuration of image forming apparatus according to an embodiment of the invention.

### DESCRIPTION OF THE PREFERRED EMBODIMENTS

The best embodiment (hereinafter referred to as the “embodiment”) for implementing the invention will be detailed referring to attached drawings.

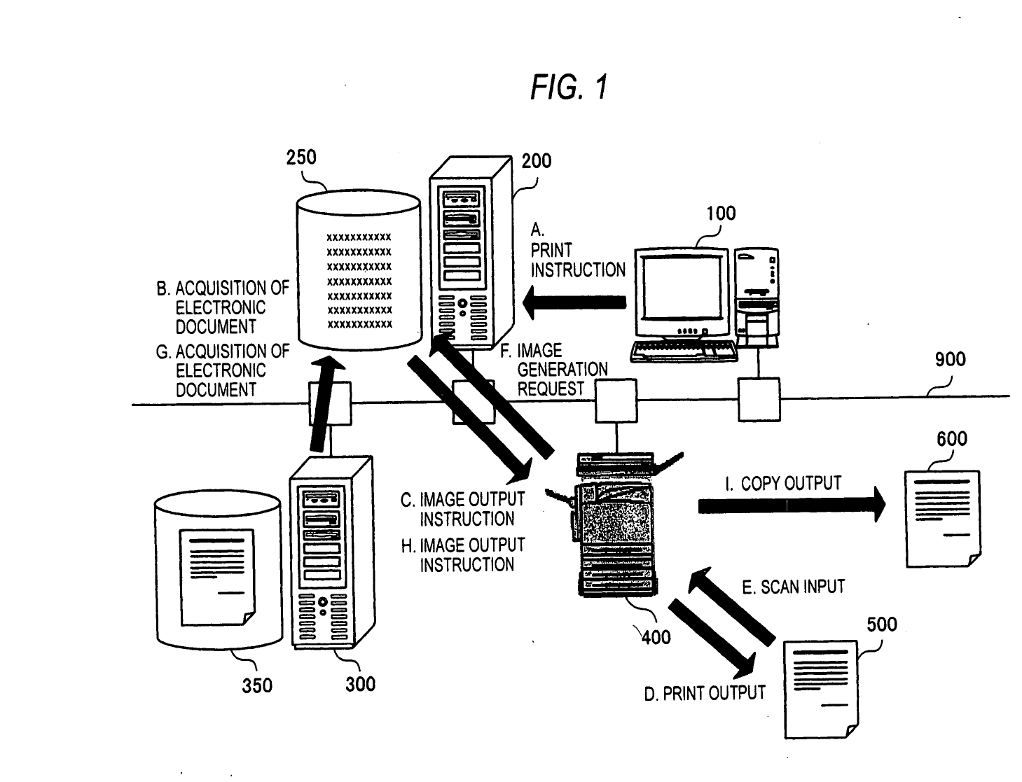

FIG. 1 shows an exemplary configuration of a system to which the invention is applied. The system includes at least: terminal apparatus 100 for instructing printing of an electronic document; an identification information management server 200 for managing identification information assigned to a medium when an electronic document is printed and generating an image including a code image containing the identification information, the code image overlaid on an image of the electronic document; a document management server 300 for managing an electronic document; and image forming apparatus 400 for printing an image including a code image overlaid on an image of the electronic document; all these components connected to a network 900.

To the identification information management server 200 is connected an identification information repository serving as storage apparatus for storing identification information. To the document management serve 300 is connected a document repository 350 serving as storage apparatus for storing an electronic document.

The system further includes a printed matter 500 output on the image forming apparatus 400 in response to an instruction from the terminal apparatus 100 and a copy 600 obtained by scanning the printed matter 500 into the image forming apparatus 400.

Operation of the system will be outlined.

The terminal apparatus 100 instructs the identification information management server 200 to print an image of the electronic document managed in the document repository 350 with a code image overlaid thereon (A). From the terminal apparatus 100, printing attributes such as a paper size, orientation, scaling, N-up (printing to allocate N pages of the electronic document in a single page of paper) and double-sided printing.

The identification information management server 200 acquires an electronic document of which printing is instructed from the document management server 300 (B). The identification information management server 200 then assigns identification information managed in the identification information repository 250 and a code image including position information determined in accordance with the printing attributes to the acquired image of the electronic document, and instructs printing of the resulting image to the image forming apparatus 400 (C). The identification information refers to information used to uniquely identify individual media (sheets) on which an image of the electronic document is printed. The position information refers to information used to identify a coordinate position (X coordinate and Y coordinate) of an individual medium.

After that, the image forming apparatus 400 outputs a printed matter 500 in accordance with an instruction from the identification information management server 200 (D).

As detailed later, the image forming apparatus 400 forms a code image assigned by the identification information management server 200 as an invisible image using invisible toner and forms the other images (images of a portion included in the original electronic document) as visible images by using visible toner.

Assume that the printed matter 500 thus output is scanned into the image forming apparatus 400. In this practice, the image forming apparatus 400 makes a inquiry to the identification information management server 200 about the latest version of the electronic document corresponding to the printed matter 500, and for example, transmits an image formation request to assign a code image to an image of the electronic document of the latest version (F).

The identification information management server 200 thus acquires the electronic document of the latest version from the document management server 300(G). The identification information management server 200 assigns identification information managed in the identification information repository 250 and a code image including position information determined in accordance with the printing attributes to the acquired image of the electronic document, and instructs printing of the resulting image to the image forming apparatus 400 (H).

After that, the image forming apparatus 400 outputs a copy 600 in accordance with an instruction from the identification information management server 200 (I).

The above configuration is an example. A single server may include the function of the identification information management server 200 and the function of the document management server 300. The function of the identification information management server 200 may be provided in the image processor of the image forming apparatus 400. While an electronic document is a target of printing in this embodiment, electronic data that does not belong to the category of an electronic document, such as a photograph image, may be processed as a target of printing. In such a case, an “electronic document” may be read as “data”.

Configuration and operation of this system will be detailed.

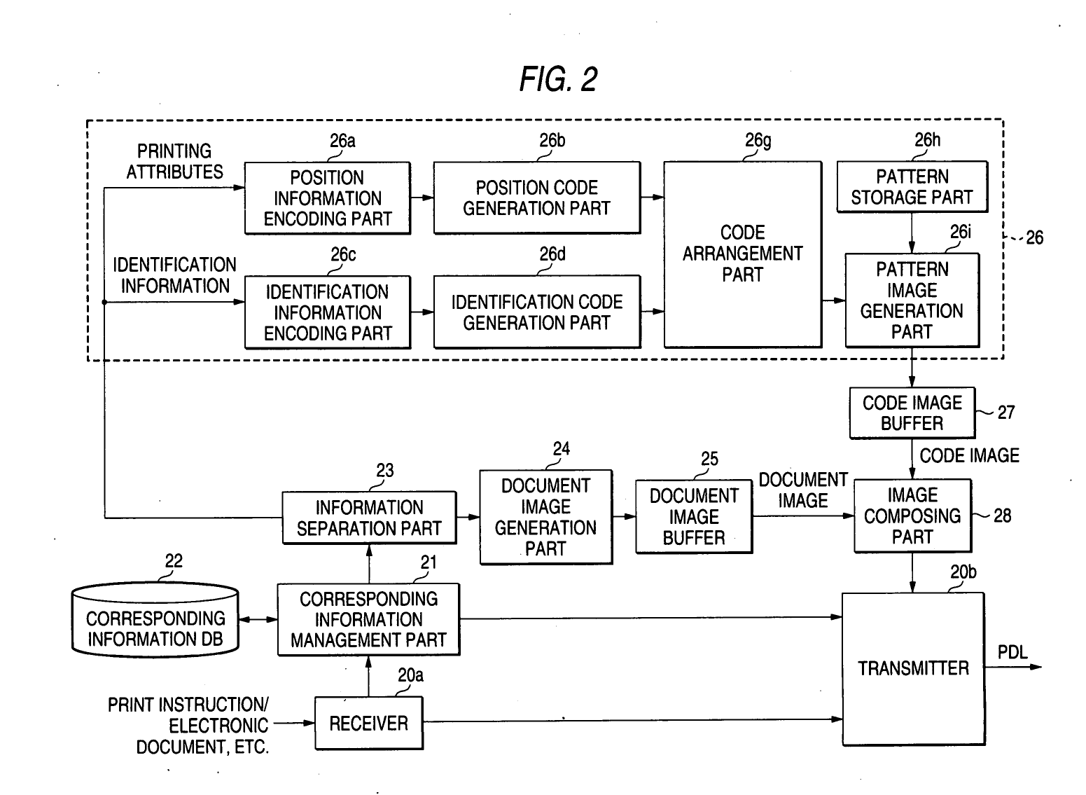

FIG. 2 shows an exemplary configuration of the identification information management server 200.

The identification information management server 200 comprises a receiver 20a, a corresponding information management part 21, a corresponding information database (DB) 22, an information separation part 23, a document image generation part 24, a document image buffer 25, a code image generation part 26, a code image buffer 27, an image composing part 28, and a transmitter 20b.

The code image generation part 26 comprises a position information encoding part 26a, a position code generation part 26b, an identification information encoding part 26c, an identification code generation part 26d, a code arrangement part 26g, a pattern storage part 26h, and a pattern image generation part 26i.

The receiver 20a receives various information such as a print instruction and an electronic document to be printed from a network 900.

The corresponding information management part 21 registers/reads information in/from the corresponding information DB 22.

When the printed matter 500 mentioned later is copied, the receiver 20a receives (acquired) identification information from the printed matter 500 (first identification information) and the corresponding information management part 21 references the corresponding information DB 22 to identify the electronic document (first electronic document) corresponding to the first identification information. After making an inquiry to the document management server 300 about the version information on the first electronic document, the receiver 20a identifies the electronic document (second electronic document) related to the first electronic document. The corresponding information management part 21 issues (acquires) the identification information (second identification information) to be registered in the corresponding information DB 22 in association with the second electronic document. Thus, the receiver 20a may serve as a first identification information acquiring part or a second electronic document identification part. The corresponding information management part 21 may serve as a first electronic document identification part or a second identification information acquiring part.

The corresponding information DB 22 is a database for storing corresponding information such as identification information to identify a medium and a storage location of an electronic document as a source of the image printed on the medium.

The information separation part 23 separates the information passed from the corresponding information management part 21 into information required to generate a document image and information required to generate a code image.

The document image generation part 24 turns an electronic document into an image based on the information required to generate a document image separated by the information separation part 23 and stores the resulting image into the document image buffer 25.

The code image generation part 26 generates a code image based on the information required to generate a code image separated by the information separation part 23 and stores the code image into the code image buffer 27.

The image composing part 28 composes a document image stored in the document image buffer 25 with a code image stored in the code image buffer 27.

The transmitter 20b transmits, as a PDL (Page Description Language) such as PostScript, an instruction to output a composite image from the image composing part 28 to the image forming apparatus 400.

The position information encoding part 26a encodes position information in accordance with a predetermined encoding system. The encoding process may use an RS (Reed-Solomon) code or BCH code as known error correcting code. As an error detection code, the CRC (Cyclic Redundancy Check) or a check sum value of position information may be calculated and the obtained value may be added to position information as redundancy bits. An M-series code as one type of pseudo noise series may be used as position information. In particular, an M-sequence code of the Pth-order M-sequence sequence length of 2^{P-1}) performs encoding by taking advantage of the property that, when a partial sequence of length P is extracted from the M-sequence, a bit pattern appearing in the partial sequence appears only once in the M-sequence.

The position code generation part 26b converts the encoded position information into a format in which the information is embedded as code information. For example, in order to make decoding by a third party more difficult, it is possible to change or encrypt the arrangement of bits in the encoded position information by way of pseudo random numbers or the like. In case position codes are arranged two-dimensionally, bit values should be arranged two-dimensionally, same as the arrangement of codes.

In this embodiment, the position code generation part 26b selects encoded position information corresponding to the printing attributes passed from the information separation part 23 from among the encoded position information already generated and stored for each printing attribute. When printing attributes such as a paper size, orientation, scaling, and N-up are determined, a single position code to be printed on a sheet is identified.

In case the printing attributes are always the same, the same position code is printed on a sheet. In case printing always uses the same printing attributes, the position information encoding part 26a and the position code generation part 26b may be integrated into a position code storing part for storing a set of position codes and the position codes may be used each time printing takes place.

When identification information is input, the identification information encoding part 26c encodes identification information in accordance with a predetermined encoding system. The encoding process nay use the same particular system as that used to encode position information.

The identification code generation part 26d converts the encoded identification information into a format in which the information is embedded as code information. For example, in order to make decoding by a third party more difficult, it is possible to change or encrypt the arrangement of bits in the encoded identification information by way of pseudo random numbers or the like. In case identification codes are arranged two-dimensionally, bit values should be arranged two-dimensionally, same as the arrangement of codes.

The code arrangement part 26g composes encoded position information with encoded identification information arranged in the same format as codes and generates a two-dimensional array of codes corresponding to the output image size. As encoded position information, codes obtained by encoding position information different depending on the arrangement position are used. As encoded identification information, codes obtained by encoding the same information irrespective of its position are used.

The pattern image generation part 26i checks the bit value of an array element in a two-dimensional code array, acquires a bit pattern image corresponding to each bit value from the pattern storage part 26h, and outputs the bit pattern image as a code image representing the two-dimensional code array in an image.

These functional parts are provided by collaboration of software and hardware resources. To be more specific, A CPU (not shown) in the identification information management server 200 reads programs to provide each function of the receiver 20a, the corresponding information management part 21, the information separation part 23, the document image generation part 24, the code image generation part 26, the image composing part 28, and the transmitter 20b, from external storage apparatus to main storage apparatus and performs processing.

Operation of transmitting an image output instruction to he image forming apparatus 400 by the identification information management server 200 in response to an instruction from the terminal apparatus 100 will be described.

In the identification information management server 200, the receiver 20a receives an instruction including specification of the storage location of the target electronic document and printing attributes from the terminal apparatus 100. Of the received information, the printing attributes are passed to the corresponding information management part 21, which retains the printing attributes. The storage location of the electronic document is passed to the transmitter 20b, which transmits a request to acquire an electronic document to be printed from the storage location to the document management server 300.

The document management server 300 then transmits the electronic document to be printed to the identification information management server 200. In the identification information management server 200, the receiver 20a receives this electronic document and passes it to the corresponding information management part 21. The corresponding information management part 21 extracts identification information from the identification information repository 250 and registers association of the identification information with the storage location of the electronic document in the corresponding information DB 22. In case specification of a specific position of the electronic document to be printed provides a link to the reference-target electronic document, association of the location information with the storage location of the electronic document as a target of reference is also registered in the corresponding information DB 22.

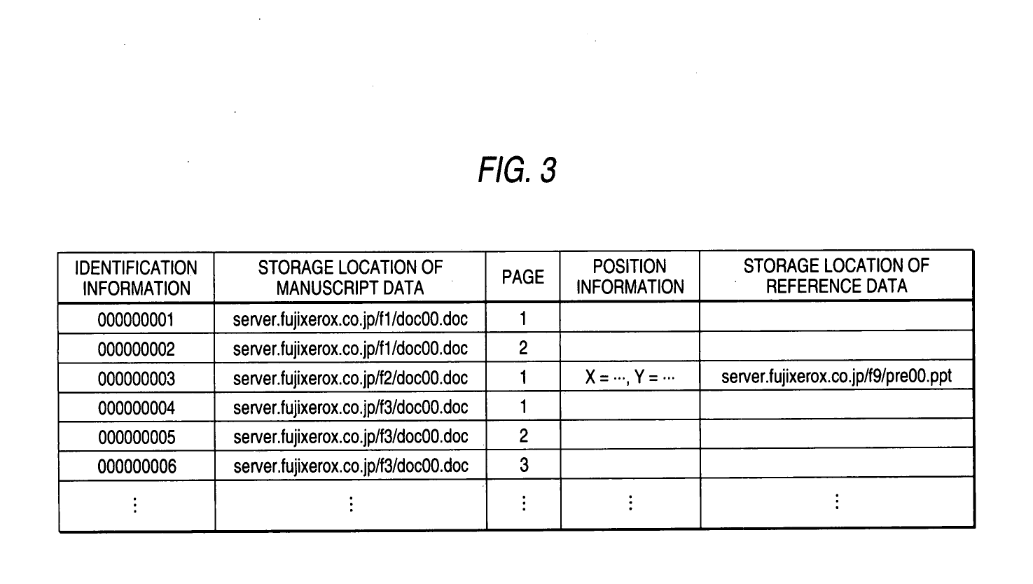

Content of the corresponding information DB 22 will be described referring to FIG. 3.

As shown in FIG. 3, the corresponding information DB 22 includes at least identification information, the storage location of the electronic document (manuscript data) to be printed, page numbers in the manuscript data, the position information in the manuscript data, and the electronic document (reference data) to be referenced in accordance with the specification of the position information.

For example, the identification information “00000001” is assigned to the first page of the manuscript data “doc00.doc” under the folder “server.fujixerox.co.jp/f1” and the identification information “00000002” is assigned to the second page of the same manuscript data.

The manuscript data “doc00.doc” under the folder “server.fujixerox.co.jp/f2” includes only a single page. When a particular position in the data is specified, it is shown that the reference data “pre00.ppt” under the folder “server.fujixerox.co.jp/f9” is made accessible. An example of a case where such a document is assumed is one in which “dic00.doc” is a conference holding notice and “pre00.ppt” is a presentation material used in the conference.

The identification information employs serial numbers in this example. An arrangement in which identification information is generated by using a combination of identification information on the image forming apparatus and an image formation date/time will provide an additional effect of recording of an output history on a medium through update of identification information by the processing mentioned later.

In this way, when information is registered in the corresponding information DB 22, the corresponding information management part 21 passes the electronic document, identification information, and printing attributes retained beforehand to the information separation part 23.

The information separation part 23 separates the received information into information required to generate a code and information required to generate a document image, and outputs the former to the code image generation part 26 and the latter to the document image generation part 24.

Thus, the position information corresponding to the printing attributes is encoded in the position information encoding part 26a and a position code indicating the encoded position information is generated in the position code generation part 26b. The identification information is encoded in the identification information encoding part 26c and an identification code indicating the encoded identification information is generated in the identification code generation part 26d.

A two-dimensional code array corresponding to the output image size is generated by the code arrangement part 26g. A pattern image corresponding to the two-dimensional code array is generated by the pattern image generation part 26i.

The document image generation part 24 generates a document image of an electronic document.

Finally, the document image generated by the document image generation part 24 is composed with the code image already generated by the code image generation part 26 in the image composing part 28, and the composite image is passed to the transmitter 20b. The transmitter 20b transmits an instruction to output the composite image to the image forming apparatus 400.

In response to the image output instruction, the image forming apparatus 400 prints the target composite image of the document image of the electronic document and the code image on a medium to provide the user with a printed matter 500.

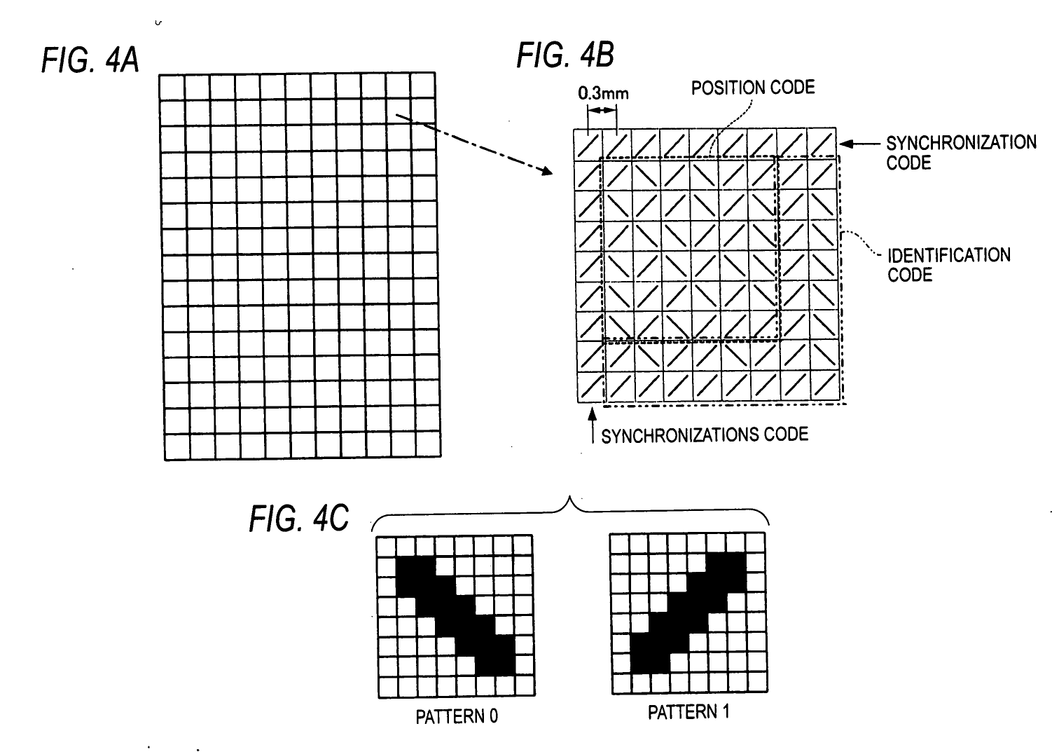

FIGS. 4A through 4C illustrate two-dimensional code images generated by the code image generation part 26 of the identification information management server 200 and printed by the image forming apparatus 400. FIG. 4A is formed by an invisible image and represents the image in a lattice-like shape in order to provide a schematic view of the unit of the two-dimensional code image arranged. FIG. 4B shows a single unit of the invisible two-dimensional code image recognized by way of irradiation of infrared light. FIG. 4C illustrates oblique line patterns of a backward slash (\) and a forward slash (/).

A two-dimensional code image formed in the image forming apparatus 400 is formed with invisible toner having a maximum absorption ratio of 7 percent or below for example in a visible light region (400-700 nm) and a maximum absorption ratio of 30 percent or below for example in a near infrared light region (800-1000 nm). Invisible toner having an average dispersion diameter of 100 to 600 nm is used in order to enhance the near infrared light absorbing capability necessary to read an image on a machine. The term “visible” or “invisible” has no connection with whether the image is visually recognizable or not. The distinction between them is based on whether an image formed on a printed medium can be recognized by way of the presence/absence of a coloring property caused by absorption of a specific wavelength in the visible light region.

The two-dimensional image shown in FIGS. 4A through 4C is formed by an invisible image that allows stable machine-reading by irradiation of infrared light and decoding for a substantial period as well as high-density recording of information. It is preferable that the invisible image may be provided in any region, irrespective of the region where the visible image on the medium surface for output of an image is provided. In this embodiment, an invisible image is formed on the entire surface of the medium face (sheet) while tailored to the size of the print medium. For example, an invisible image recognized by way of a difference in luster is more favorable. Note that the “entire surface” does not mean to include all of the four corners of a sheet.

A two-dimensional code pattern shown in FIG. 4B includes a region storing a position code indicating the coordinates of the image on the medium and a region storing an identification code for uniquely identifying the electronic document or print medium, and also a region storing a synchronization code. As shown in FIG. 4A, a plurality of such two-dimensional code patterns are arranged and two-dimensional codes in which different position information is stored are arranged in a lattice-like shape on the entire surface of the medium face (sheet) while tailored to the size of the print medium. That is, a plurality of two-dimensional code patterns shown in FIG. 4B are arranged on the medium face and each pattern includes a position code, an identification code and a synchronization code. In the region of the plurality of position codes is stored position information that differs with respective locations. In the region of the plurality of identification codes is stored the same identification information irrespective of the location of each of the codes.

Referring to FIG. 4B, a position code is arranged in a rectangular region of 6 by 6 bits. Each bit value is formed by a plurality of small line bitmaps whose rotation angles are different. A bit value 0 and a bit value 1 are represented by oblique line patters (pattern 0 and pattern 1) as shown in FIG. 4C. To be more specific, a backward slash (\) and a forward slash (/) having different inclinations from each other are used to represent bit 0 and bit 1. Each oblique line pattern has a size of 8 by 8 pixels (600 dpi). The diagonal line pattern left upward (pattern 0) represents a bit value 0 and the diagonal line pattern right upward (pattern 1) represents a bit value 1. By using small line bitmaps including two types of inclination, it is possible to provide a two-dimensional code pattern with negligible noise appearing on a visible image that allows huge information to be digitized in high density and embedded therein.

In the position code region shown in FIG. 4B is stored position information of total 36 bits. Of the 36 bits, 18 bits may be used to encode X coordinate and 18 bits Y coordinate. When 18 bits are used to encode positions, the number of positions encoded is as many as 2¹⁸ (approximately 260 thousand). In case each diagonal line pattern is composed of 8 by 8 pixels (600 dpi) as shown in FIG. 4C, a single dot of 400 dpi has a width of 0.0423 mm. The size of a two-dimensional code shown in FIG. 4B (including a synchronization code) is about 3 millimeters (8 pixels×9 bits×0.0423 mm) both vertically and horizontally. In case 260 thousand positions are encoded in intervals of 3 mm, a length of about 786 m can be encoded. All of the 18 bits may be used to encode positions in this way. Or, in the presence of a diagonal line pattern detection error, redundancy bits for error detection or error correction may be included.

Identification codes are arranged in rectangular regions of 2 by 8 bits and 6 by 2 bits. Identification information of total 28 bits may be stored. In case 28 bits are used as identification information, it is possible to represent 2²⁸ (approximately 270 million) items of identification information. Same as the position code, the identification code may include redundancy bits for error detection or error correction.

In the example of FIG. 4C, two diagonal line patterns have an angle difference of 90 degrees. In case the angle difference is 45 degrees, four diagonal line patterns may be provided. In such a case, it is possible to represent 2-bit information (0-3) by using a single diagonal line pattern. That is, by increasing the angle types of diagonal line pattern, it is possible to increase the number of bits to be represented.

While encoding of a bit value is illustrated using diagonal line patterns in the example shown in FIG. 4C, available patterns may be other than a diagonal line pattern. Dot ON/OFF or a direction dot position is shifted from a reference position may be used for encoding.

Next, operation of scanning the printed matter 500 thus obtained into the image forming apparatus 400 and acquiring the copy 600 will be described. In this embodiment, the copy 600 thus obtained is not always a direct copy of the printed matter 500. In case an electronic document corresponding to the printed matter 500 is upgraded, the copy 600 may correspond to the upgraded version of the electronic document.

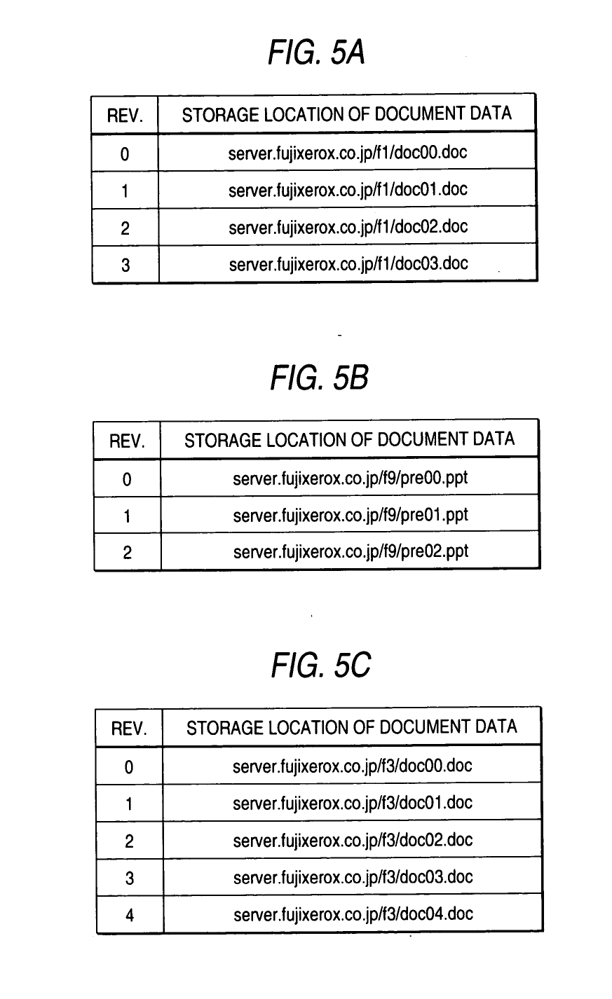

For example, assume that the printed matter 500 was output on the image forming apparatus 400 concerning an electronic document managed in the corresponding information DB 22 shown in FIG. 3 and then the update shown in FIG. 5 has taken place. In FIG. 5, the “Rev.” column represents a version. Storage location of the electronic document corresponds to each version. The information is the electronic document management information so that the information is managed by the document management server 300 in this embodiment.

FIG. 5A shows a history of update of manuscript data “doc00.doc” under the folder “server.fujixerox.co.jp/f1”. The electronic document of version 0 (original version) is “doc00.doc” while version 1 is “doc01.doc” and version 2 is “doc02.doc” and version 3 is “doc03.doc”. In this way, each version has a different file name.

FIG. 5B shows a history of update of reference data instead of a history of update of manuscript data shown in FIG. 5A. That is, FIG. 5B shows a history of update of the reference data “pre00.ppt” under the folder “server. fujixerox.co.jp/f9”. Same as FIG. 5A, file names are differently given for version 0 (original), version 1, and version 2.

Similar to FIG. 5A, FIG. 5C shows a history of update of manuscript data. File names are differently given for version 0 (original), version 1, version 2, version 3, and version 4.

While file names are differently given for different versions in this example, a same file name may be used for different versions in case a file system capable of managing different versions with a single file name is used.

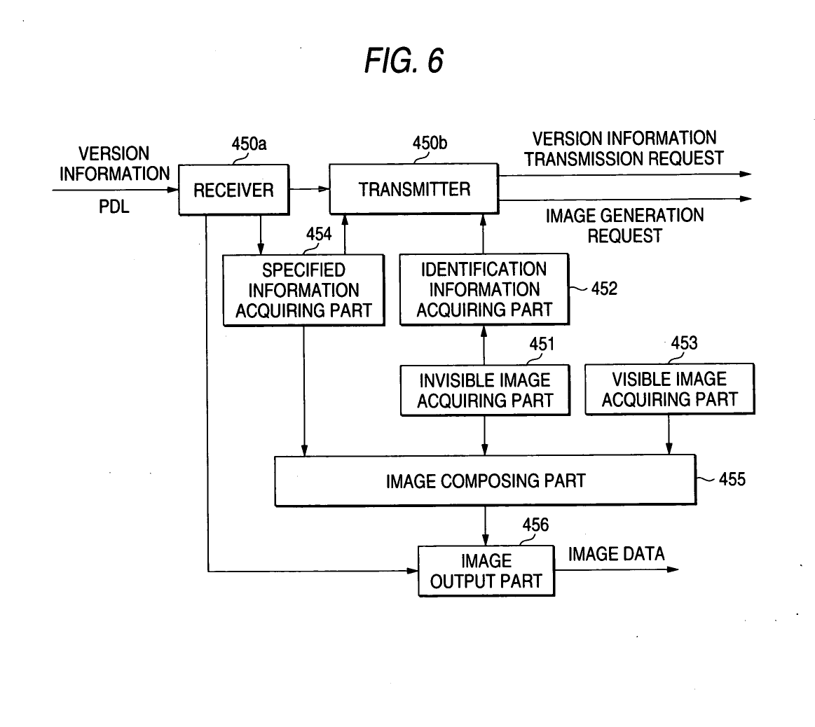

Next, the configuration of the image forming apparatus 400 related to the operation from scanning of the printed matter 500 to output of an image to be printed on the copy 600 will be described referring to FIG. 6.

The portion of the image forming apparatus 400 related to this operation comprises a receiver 450a, an invisible image acquiring part 451, an identification information acquiring part 452, a visible image acquiring part 453, a specified information acquiring part 454, an image composing part 455, an image output part 456, and a transmitter 450b.

The receiver 450a receives information on which versions of an electronic document corresponding to the scanned medium are available (“version information”) and a PDL describing an instruction to output an image where a code image is overlaid on a document image.

The invisible image acquiring part 451 irradiates infrared light to recognize an invisible image. The identification information acquiring part 452 extracts identification information from the invisible image. The visible image acquiring part 453 acquires a visible image by way of a known scanner mechanism.

The specified information acquiring part 454 prompts the user to specify a version of an electronic document or a method for adding a code image and acquires the information specified by the user.

The image composing part 455 composes an invisible image with a visible image in accordance with the information acquired by the specified information acquiring part 454.

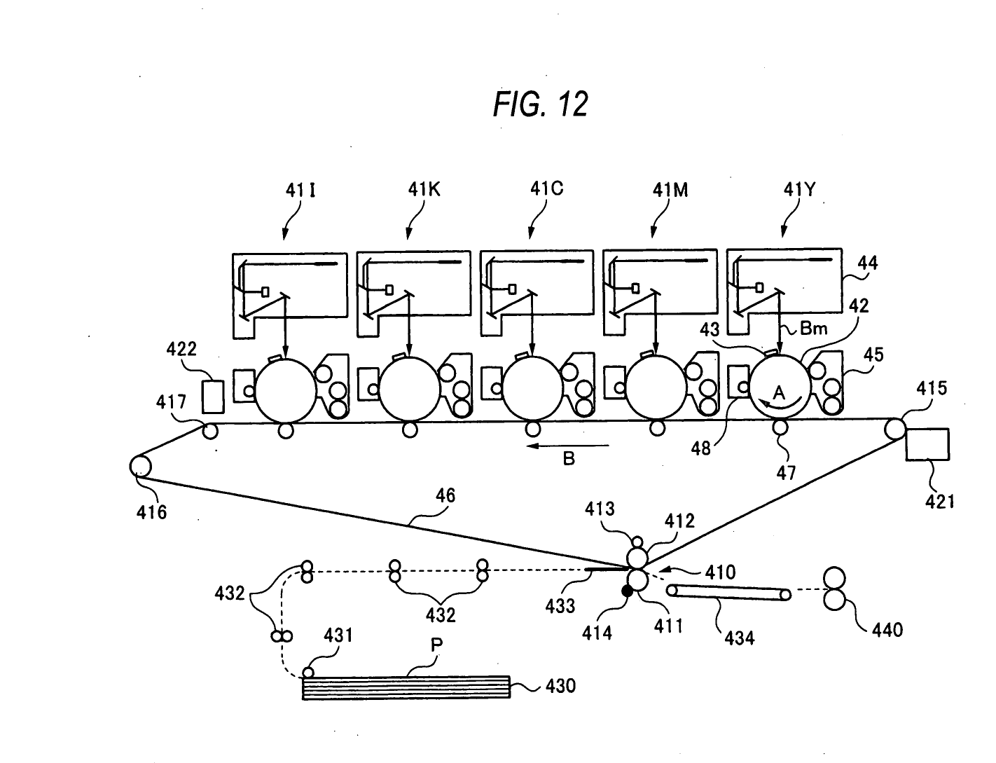

The image output part 456 receives the composite image or an image generated by the identification information management server 200 and outputs the image to the main unit of the image forming apparatus 400 (the mechanism shown in FIG. 12 mentioned later). The image output part 456 includes a function to acquire an image to be output so that it may serve as an image acquiring part.

The transmitter 450b transmits a request to transmit version information and a request to generate an image to be output.

Operation of acquiring the copy 600 on which an image of an electronic document of a desired version is printed will be described. The operation is carried out when the image forming apparatus 400 thus configured and the identification information management server 200 having the configuration mentioned earlier exchange information.

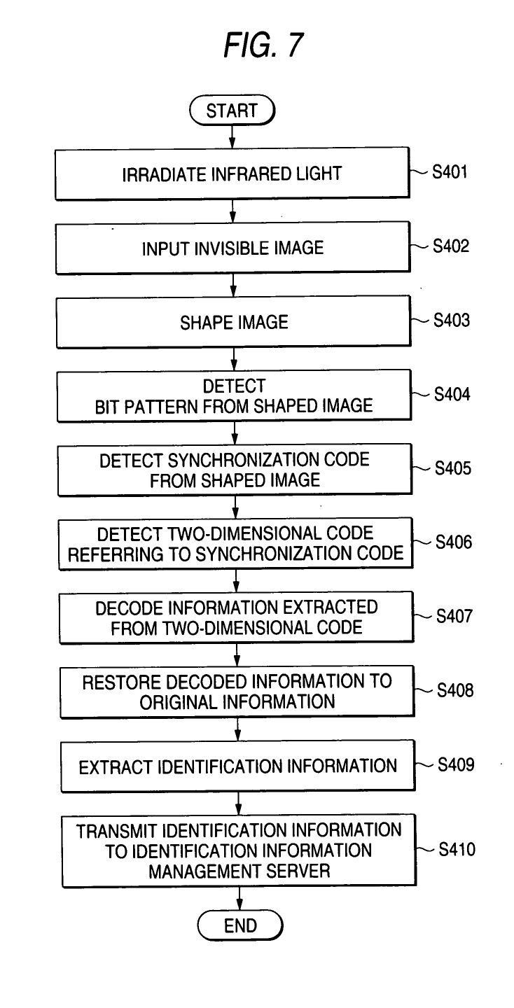

Referring to FIG. 7, the operation of the image forming apparatus 400 recognizing a code image from a scanned image and acquiring identification information will be described. A visible image other than a code image is acquired by the visible image acquiring part 453 by using a known technology.

When a medium is placed on a platen, the invisible image acquiring part 451 irradiates infrared light onto the medium (step 401). The infrared light irradiated onto the medium is absorbed by an invisible image and is reflected elsewhere. The invisible image acquiring part 451 intercepts the reflected infrared light and recognizes the portion where infrared light was not detected as a code image and inputs the image (step 402).

The invisible image acquiring part 451 then executes code image detection processing in steps 403 through 409. The invisible image acquiring part 451 shapes the input scanned image (step 403). Shaping of the scanned image includes inclination correction and noise removal. From the shaped scanned image, a bit pattern (oblique line pattern) of a forward slash (/) or a backward slash (\) is detected (step 404). IN the meantime, a synchronization code for positioning of a two-dimensional code is detected from the shaped scanned image (step 405). The invisible image acquiring part 451 references the synchronization code to detect a two-dimensional code (step 406). The invisible image acquiring part 451 also extracts information such as an ECC (Error Correcting Code) from the two-dimensional code and decodes the two-dimensional code (step 407), then restores the decoded information to the original information (step 408).

Next, the identification information acquiring part 452 extracts identification information from the code information thus restored (step 409). The identification information is transmitted to the identification information management server 200 wiredly or wirelessly (step 410).

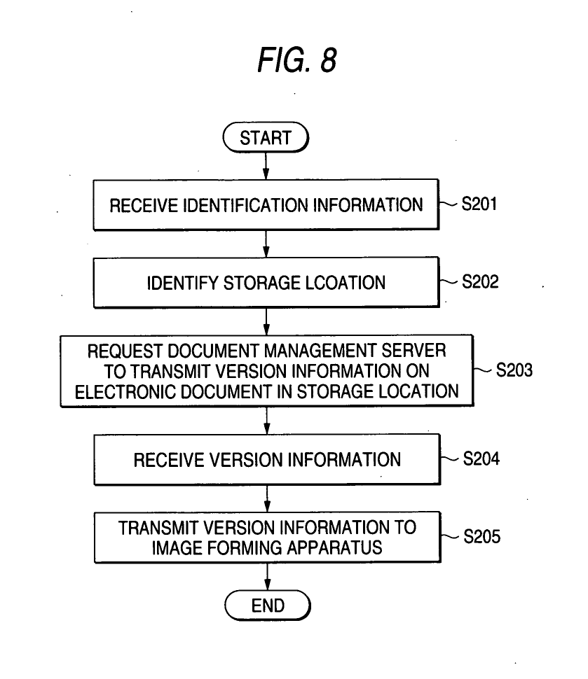

The identification information management server 200 thus performs operation shown in FIG. 8.

In the identification information management server 200, the receiver 20a receives identification information and passes it to the corresponding information management part 21 (step 201). The corresponding information management part 21, receiving the identification information, references the corresponding information DB 22 and identifies the storage location of an electronic document corresponding to the identification information and reports the storage location to the transmitter 20b (step 202). The transmitter 20b requests the document management server 300 to transmit version information on the electronic document in the storage location (step 203).

In response to this request, the document management server 300 acquires version information based on the information shown in FIG. 5 and transmits the version information to the identification information management server 200. The receiver 20a in the identification information management server 200 receives the version information (step 204). The version information is passed to the transmitter 20b and is transmitted to the image forming apparatus 400 from the transmitter 20b (step 205).

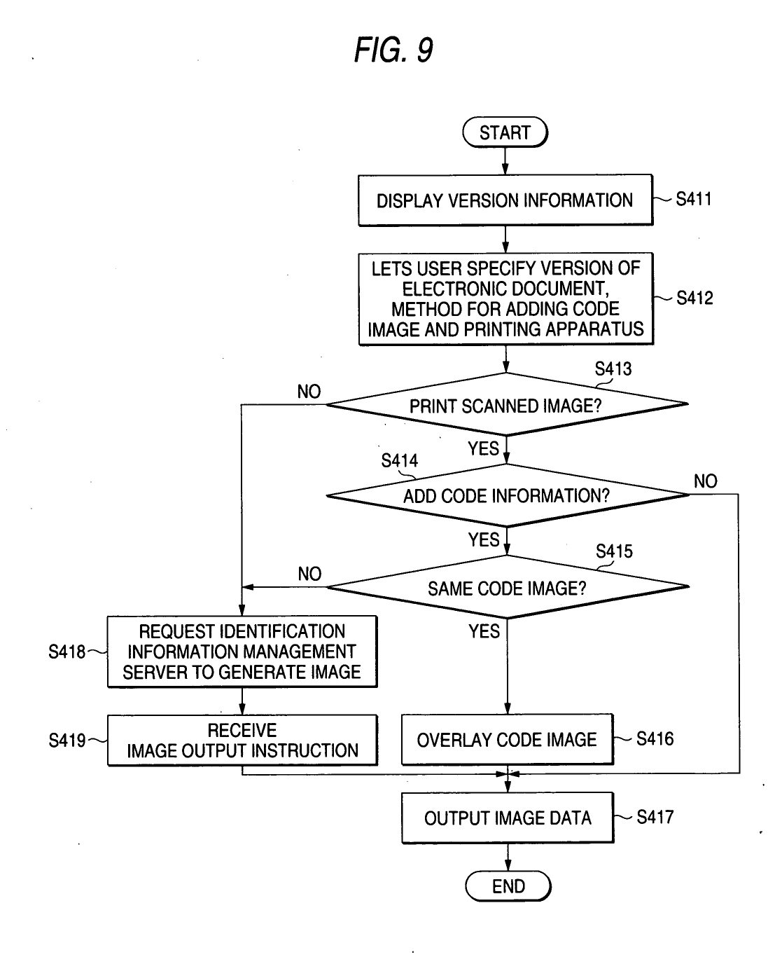

Then the image forming apparatus 400 performs operation shown in FIG. 9. That is, the version information received by the receiver 450a is passed to the specified information acquiring part 454, which displays the version information on a display unit (not shown) of the image forming apparatus 400 (step 411). For example, information such as when and what updates have been made to an electronic document as a source of the image printed on the scanned medium is displayed. In case the electronic document is updated, an inquiry message is also displayed about whether the version corresponding to the scanned medium is left unchanged or any of the subsequent versions (desirably the latest version) is employed. Selections are also displayed, concerning a code image to be added to the copy 600, including “do not add a code image”, “add the same code image as that already embedded into the scanned medium”, “add a code image different from that already embedded into the scanned medium, and add the same code image to all copies”, and “add a code image different from that already embedded into the scanned medium, and add a different code image to each of the copies”.

When the user specifies desired conditions as well as printing attributes such as a paper size, orientation, scaling, N-up and double-sided printing, the specified information acquiring part 454 acquires the specified information (step 412) and performs processing accordingly.

In other words, the specified information acquiring part 454 first determines whether it is instructed to print the scanned image as it is (step 413).

As a result, in case it is specified that the scanned image be printed as it is, the specified information acquiring part 454 determines whether to add a code image (step 414).

In case it is determined that a code image be not added, the specified information acquiring part 454 notifies the image composing part 455 as such. The image composing part 455 passes to the image output part 456 a visible image alone acquired by the visible image acquiring part 453. The image output part 456 outputs the visible image alone to the main unit of the image forming apparatus 400 (step 417).

In case it is determined that a code image be added, the specified information acquiring part 454 determines whether to add the same code image as that embedded into the scanned image (step 415). In case the same code image is to be added, the specified information acquiring part 454 notifies the image composing part 455 as such. The image composing part 455 overlays the visible image acquired by the visible image acquiring part 453 on the invisible image acquired by the invisible image acquiring part 451 (step 416) and passes the resulting image to the image output part 456. The image output part 456 outputs the image to the main unit of the image forming apparatus 400 (step 417).

In case it is specified that the scanned image be not printed as it is, or in case it is specified that the scanned image be printed with a different code being printed, control is passed to the transmitter 450b, which requests the identification information management server 200 to generate a new image (step 418). The former case may correspond to a case of printing the image of an electronic document of a new version. The latter case may correspond to a case of changing the link destination embedded in the image alone to a new version.

In this way, an image is generated in the identification information management server 200 and an image output instruction is transmitted to the image forming apparatus 400. In the image forming apparatus 400, the receiver 450a receives the image output instruction and passes it to the image output part 456 (step 419). The image output part 456 then outputs the image data to the main unit of the image forming apparatus 400 (step 417).

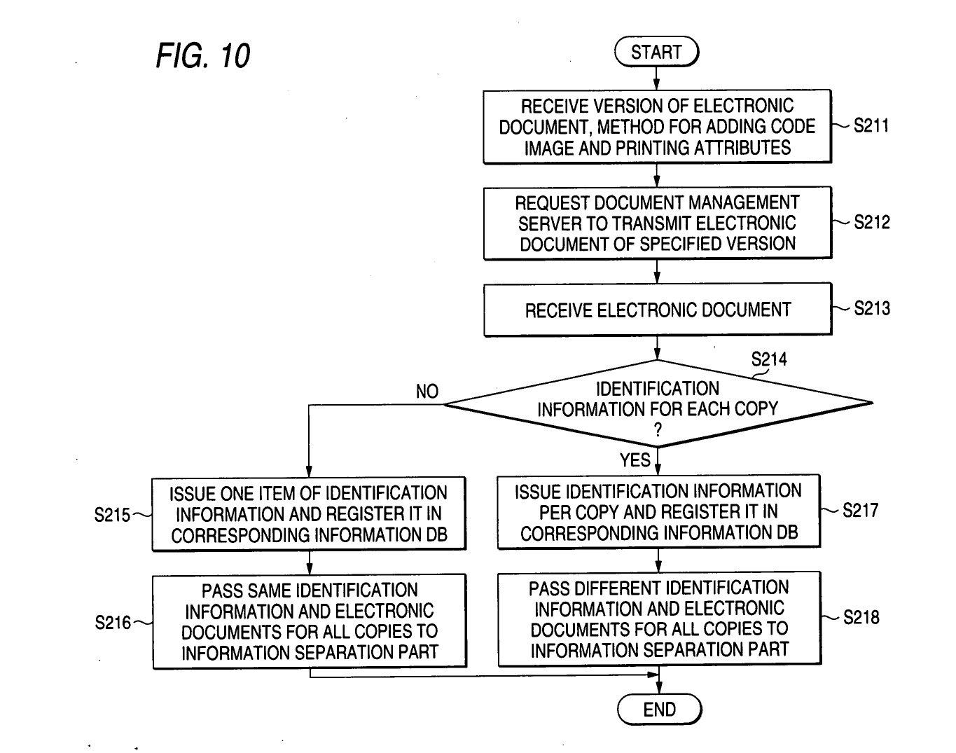

Operation of the identification information management server 200 that received an image generation request transmitted in step 418 will be described referring to FIG. 10. The image generation request transmitted in step 418 includes a version to be printed, a method for adding code information, and printing attributes.

First, in the identification information management server 200, the receiver 20a receives the above information (step 211). The received information is transmitted to the transmitter 20b, which requests the document management server 300 to transmit a specified version of the target electronic document (step 212). The document management server 300 transmits the electronic document of the requested version to the identification information management server 200. In the identification information management server 200, the receiver 20a receives the electronic document and passes it to the corresponding information management part 21 (step 213).

The corresponding information management part 21 determines whether it is specified that different identification information be assigned to each copy (step 214).

In case it is not necessary to assign different identification information to each copy, the corresponding information management part 21 extracts an item of identification information from the identification information repository 250 and registers association of the identification information with the storage location of the electronic document of the version in the corresponding information DB 22. In case specification of a specific position of the electronic document to be printed provides a link to the reference-target electronic document, association of the location information with the storage location of the electronic document as a target of reference is also registered in the corresponding information DB 22 (step 215). The corresponding information management part 21 passes as many sets of the same item of identification information and the electronic document as the number of copies to the information separation part 23 (step 216).

In case it is necessary to assign different identification information to respective copies, the corresponding information management part 21 extracts as many items of identification information as the number of copies from the identification information repository 250 and registers as many associations as the number of copies of the identification information with the storage location of the electronic document of the version in the corresponding information DB 22. In case specification of a specific position of the electronic document to be printed provides a link to the reference-target electronic document, association of the location information with the storage location of the electronic document as a target of reference is also registered in the corresponding information DB 22 (step 217). The corresponding information management part 21 passes as many sets of different items of identification information and the electronic document as the number of copies to the information separation part 23 (step 218).

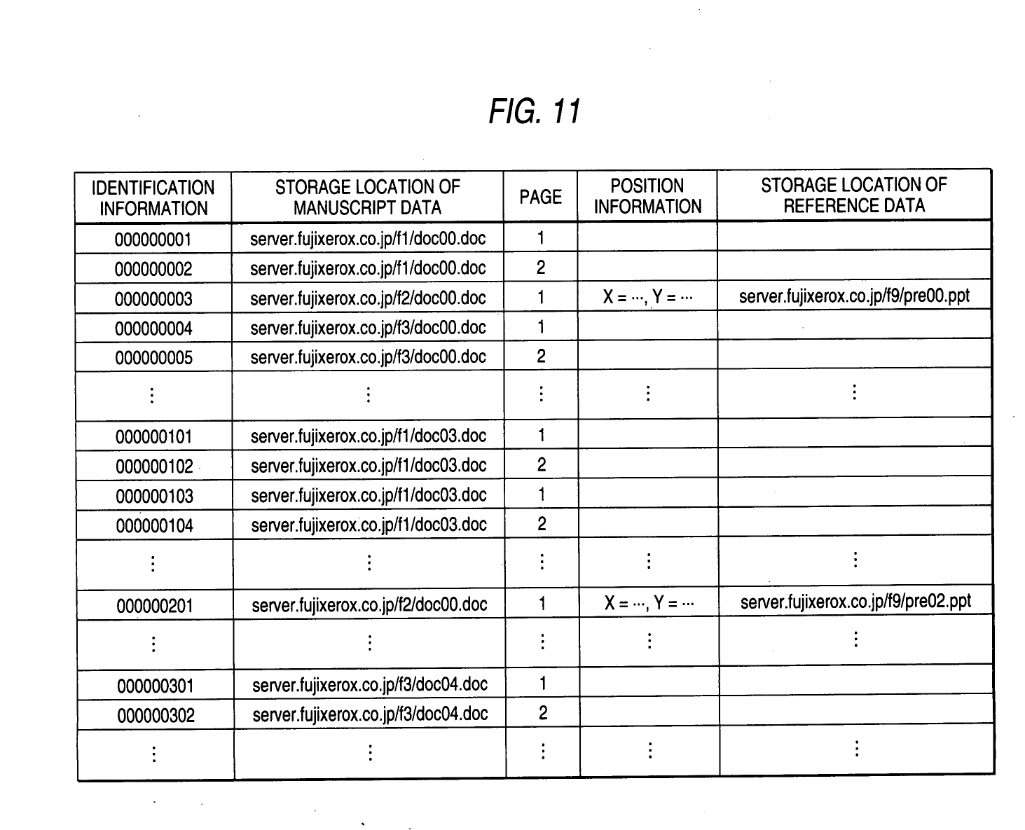

The content of the corresponding information DB 22 will be described referring to FIG. 11.

FIG. 11 shows, as additional information to the arrangement in FIG. 3, identification information “00000101” through “00000104”, identification information “00000201”, identification information “00000301”, “00000302”. The identification information “00000101” through “00000104” is information registered when printing is made using the latest version of an electronic document corresponding to the identification information “00000301”, “00000302”. In this example, different identification information is assigned to the same page of the same manuscript data. In other words, this is a case where different identification information is assigned to each copy such as in steps 217, 218.

The identification information “00000201” is information registered when reference data corresponding to the identification information “00000003” is updated to the latest version.

Further, the identification information “00000301”, “00000302” is information registered when printing is made using the latest version of an electronic document corresponding to the identification information “00000004”, “00000005”.

In this way, when information is registered in the corresponding information DB 22, the corresponding information management part 21 passes the electronic document, identification information, and the already acquired printing attributes to the information separation part 23.

The information separation part 23 separates the information passed from the corresponding information management part 21 into information required to generate a code image and information required to generate a document image. The information separation part 23 then outputs the former to the code image generation part 26 and the latter to the document image generation part 24.

As a result, the position information corresponding to the printing attributes is encoded in the position information encoding part 26a and a position code indicating the encoded position information is generated in the position code generation part 26b. The identification information is encoded in the identification information encoding part 26c and an identification code indicating the encoded identification information is generated in the identification code generation part 26d.

A two-dimensional code array corresponding to the output image size is generated by the code arrangement part 26g. A pattern image corresponding to the two-dimensional code array is generated by the pattern image generation part 26i.

The document image generation part 24 generates a document image of an electronic document.

Finally, the document image generated by the document image generation part 24 is composed with the code image already generated by the code image generation part 26 in the image composing part 28, and the composite image is passed to the transmitter 20b. The transmitter 20b transmits an the composite image to the image forming apparatus 400.

The image forming apparatus 400 will be detailed.

FIG. 12 shows an exemplary configuration of the image forming apparatus 400. The image forming apparatus 400 shown in FIG. 12 is a so-called tandem-type apparatus. For example, the image forming apparatus 400 comprises: a plurality of image formation units 41 (41Y, 41M, 41C, 41K, 41I) in which toner images of respective color components are formed by way of the electronic photography system; an intermediate transfer belt 46 for sequentially transferring (primarily transferring) toner images of respective color components formed by the image formation units 41 to hold the toner images; a secondary transfer unit 410 for transferring altogether (secondarily transferring) a superposed image transferred onto the intermediate transfer belt 46 on a sheet of paper (medium) P; and a fixing unit 440 for fixing the secondarily transferred image onto the sheet of paper P.

The image forming apparatus 400 comprises, besides the image formation units 41Y, 41M, 41C for forming a toner image of yellow (Y), magenta (M) and cyan (C) as normal colors (usual colors), an image formation unit 41K for forming a toner image of black (K) that does not absorb infrared light, and an image formation unit 41I for forming an invisible toner image, as image formation units constituting tandem-type apparatus.

The image formation unit 41I uses coloring materials that absorb more infrared light than Y toner, M toner, C toner and K toner used in the image formation units 41Y, 41M, 41C and 41L respectively. Such coloring materials include, for example, a coloring material including vanadyl naphthalocyanine. K toner used in the image formation unit 41K desirably uses a coloring material absorbing less infrared light than one used in the image formation unit 41I in order to facilitate detection of a code image although it is possible to use a commonly available coloring material that absorbs infrared light, such as one containing carbon.

In this embodiment, each image formation unit 41 (41Y, 41M, 41C, 41K, 41I) includes, on the periphery of a photosensitive drum 42 that rotates in the direction of arrow A, electronic photography devices sequentially arranged such as an electrifier 43 for electrifying the photosensitive drum 42, a laser exposure unit 44 for writing an electrostatic latent image onto the photosensitive drum 42 (exposure beams are shown by a sign Bm in the figure), a developer 45 including toner of respective color components for making visible an electrostatic latent image on the photosensitive drum 42 by way of toner, a primary transfer roll 47 for transferring toner images of respective colors formed on the photosensitive drum 42 onto the intermediate transfer belt 46, and a drum cleaner 48 for removing residual toner on the photosensitive drum 42. The image formation units 41 are arranged in the order of yellow (Y), magenta (M), cyan (C), black (K) and invisible (I) from upstream of the intermediate transfer belt 46.

The intermediate transfer belt 46 is arranged rotatably in the direction B shown in the figure by way of several types of rolls. The several types of rolls include a drive roll 415 for rotating the intermediate transfer belt 46 while being driven by a motor (not shown), a tension roll 416 for providing the intermediate transfer belt 46 with a certain tension while preventing the intermediate transfer belt 46 from meandering, an idle roll 417 for supporting the intermediate transfer belt 46, and a backup roll 412 (mentioned later).

To the primary transfer roll 47 is applied a voltage having the polarity opposite to the electrification polarity of toner. This causes toner images on the photosensitive drums 42 to be sequentially and electrostatically attracted to the intermediate transfer belt 46 so as to form superposed toner images on the intermediate transfer belt 46. Further, the secondary transfer unit 410 includes a secondary transfer roll 411 disposed in pressure contact with the toner image supporting face of the intermediate transfer belt 46 and a backup roll disposed on the rear surface of the intermediate transfer belt 46 to form an opposing electrode to the secondary transfer roll 411. A metallic power feed roll 413 to which a secondary transfer bias is stably applied is disposed in contact with the backup roll 412. A brush roll 414 for removing stain attached on the secondary transfer roll 411 is disposed in contact with the secondary transfer roll 411.

In the downstream of the secondary transfer roll 411 is provided a belt cleaner 421 for cleaning the surface of the intermediate transfer belt 46 after secondary transfer.

This embodiment includes, as a sheet transport system, a paper tray 430 for accommodating sheets of paper P, a pickup roll 431 for picking up sheets of paper P accumulated in the paper tray 430 with a predetermined timing and transporting the sheets of paper, transport roll 432 for transporting the sheets of paper P fed out from the pickup roll 431, a transport chute for feeding the sheets of paper P transported by the transport roll 432 into the position of secondary transfer by the secondary transfer unit 410, and a transport belt 434 for feeding the transporting sheets of paper P after secondary transfer to the fixing unit 440.

The image forming process of the image forming apparatus 400 will be described. When the start switch (not shown) is turned ON by the user, a predetermined image firming process is executed. To be more specific, for example, in case the image forming apparatus 400 is arranged as a color printer, a digital image signal transmitted from the network 900 is temporarily stored in memory. Based on digital signals of five colors (Y, M, C, K, I) stored, toner images of respective colors are formed.

That is, based on image recording signals of respective colors obtained through image processing, the image formation units 41 (41Y, 41M, 41C, 41K, 41I) are driven. In the image formation units 41Y, 41M, 41C, 41K, 41I, an electrostatic latent image according to an image recording signal is written by the laser exposure unit 44 onto each photosensitive drum 42 uniformly electrified by the electrifier 43. Each electrostatic latent image written is developed by the developer accommodating toner of respective colors to form toner images of respective colors.

A toner image formed on each photosensitive drum is primarily transferred onto the surface of the intermediate transfer belt 46 from the photosensitive drum 42 by way of a primary transfer bias applied by the primary transfer roll 47, at a position each photosensitive drum 42 comes in contact with the intermediate transfer belt 46. In this way, the toner images primarily transferred onto the surface of the intermediate transfer belt 46 are superposed one on the other on the primarily transferred onto the surface of the intermediate transfer belt 46 and transported to a secondary transfer position in accordance with the rotation of the intermediate transfer belt 46.

A sheet of paper P is transported to the secondary transfer position of the secondary transfer unit 410 with a predetermined timing. The secondary roll 411 nips the sheet of paper P with respect to the intermediate transfer belt 46 (backup roll 412). By the action of a secondary transfer electric field formed between the secondary transfer roll 411 and the backup roll 412, a superposed toner image supported by the intermediate transfer belt 46 is secondarily transferred to the sheet of paper P.

After that, the sheet of paper P where the toner image is transferred is transported to the fixing unit 440 by the transport belt 434 in order to fix the toner image. The intermediate transfer belt 46 after secondary transfer has its residual toner removed by the belt cleaner 421.

In this embodiment, in case an electronic document is upgraded, the code image on the medium is updated to for example the latest version. Note that the invention is applicable to any case in which electronic documents are in ant relation with each other as well as a case they are of an old version and of a new version.

As mentioned above, in this embodiment, when a medium with code information corresponding to an electronic document embedded therein is copied, a code image corresponding to another electronic document related to the electronic document is embedded instead of the code image. With this configuration, information embedded into a printed matter or its copy may be readily modified in accordance with an update of the source manuscript data or reference data to be referenced therein.

According to this embodiment, selections are available, in copying a medium, including “do not add a code image”, “add the same code image as that already embedded into the scanned medium”, “add a code image different from that already embedded into the scanned medium, and add the same code image to all copies”, and “add a code image different from that already embedded into the scanned medium, and add a different code image to each of the copies”. This readily provides a copy that meets a specific object of copying.

For example, in case a plurality of copies are obtained from a single printed matter, different code images are embedded into individual copies so as to find a specific copy among those distributed. That is, it may be possible to provide security of copying. In case simple processing is made without such security measures, the same code image may be uniformly added to all copies.

In this embodiment, a code image is updated to one meeting the latest version. Moreover, an image printed on a medium as a visible image may be printed based on the electronic document stored in the server. This may avoid possible degradation of image caused by repeated copying.

As described above, according to an aspect of the invention, the code image is overwritten in accordance with the updates of an electronic document corresponding to the code image when copying a medium on which a code image is formed.

It maybe possible to readily modify information embedded into a printed matter or its copy in accordance with an update of manuscript data as its source data or reference data that is referenced therein.

The entire disclosure of Japanese Patent Application No. 2005-181257 filed on Jun. 21, 2005 including specification, claims, drawings and abstract is incorporated herein by reference in its entirety.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be solely defined by the following claims and their equivalents.

What is claimed is:

1. A copy system comprising:
a server identifying a second electronic document corresponding to a first electronic document; and
an image forming apparatus that forms a second code image on a medium instead of a first code image in accordance with an instruction to copy the medium, the second code image corresponding to the second electronic document identified by the server, the first code image corresponding to the first electronic document and being formed on the medium.

2. The copy system according to claim 1, wherein the first electronic document is a source of an image other than the first code image on the medium on which the first code image is formed.

3. The copy system according to claim 2, wherein the image forming apparatus forms an image of the second electronic document on the medium when the second code image is formed on the medium.

4. The copy system according to claim 1, wherein the first electronic document is referenced by using the medium on which the first code image is formed.

5. The copy system according to claim 1, wherein the image forming apparatus specifies whether to form the different second code image on each of plurality of media in accordance with an instruction to copy one medium on which the first code image is formed to the plurality of media.

6. The copy system according to claim 1, wherein the first code image includes:
identification information on the image forming apparatus; and
information on date and time that the first code image is formed and,
wherein the second code image includes:
identification information on the image forming apparatus and
information on date and time that the second code image is formed.

7. The copy system according to claim 1, wherein the image forming apparatus outputs the information on the second electronic document in accordance with an instruction to copy the medium on which the fist code image is formed.

8. Image forming apparatus comprising:
an acceptance part that accepts b an instruction to copy a medium on which a first code image corresponding to first data is formed;
an image acquiring part that acquires an image including a second code image corresponding to second data instead of the first code image in accordance with the copy instruction, the second data being related to the first data; and
a printing part that prints an image acquired by the image acquiring part on a medium.

9. The image forming apparatus according to claim 8, wherein the first data is a source of an image other than the first code image on the medium on which the first code image is formed.

10. The image forming apparatus according to claim 8, wherein the first data is referenced by using the medium on which the first code image is formed.

11. The image forming apparatus according to claim 8, wherein the printing part prints the second code image as a substantially invisible image, and
prints an image other than the second code image as a visible image.

12. The image forming apparatus according to claim 8, wherein the printing part prints the second code image by using a material that absorbs infrared light, and
prints images other than the second code image by using color materials including yellow, cyan and magenta.

13. A server comprising:
a first identification information acquiring part that acquires a first identification information by scanning a medium on which an image including the first identification information is formed;
a first data identification part that identifies first data corresponding to the first identification information acquired by the first identification information acquiring part;
a second data identification part that identifies second data related to the first data identified by the first data identification part;
a second identification information acquiring part that acquires second identification information corresponding to the second data identified by the second data identification part; and
an image generation part that generates an image including the second identification information but not the first identification information.

14. The server according to claim 13,wherein the first data is a source of an image formed on the scanned medium.

15. The server according to claim 13, wherein the first data is referenced based on the image formed on the scanned medium.

16. An image forming method comprising:
accepting an instruction to copy a medium on which a first code image corresponding to a first electronic document is formed;
acquiring an image including a second code image corresponding to a second electronic document instead of the first code image in accordance with the instruction to copy the medium, the second electronic document being related to the first electronic document; and
printing the acquired image on the medium.

17. The image forming method according to claim 16, further comprising:
specifying whether to form the different second code image on each of plurality of media in accordance with an instruction to copy a single medium on which the first code image is formed to the plurality of media.

18. The image forming method according to claim 16, further comprising:
outputting information on the second electronic document in accordance with the copy instruction.

19. A storage medium readable by a computer, the storage medium storing a program of instructions executable by the computer to perform a function for generating an image, the function comprising:
acquiring first identification information by scanning a medium on which an image including the first identification information is formed;
identifying a first electronic document corresponding to the first identification information;
identifying a second electronic document related to the first electronic document;
acquiring second identification information corresponding to the second electronic document; and
generating an image including the second identification information but not the first identification information.
